(19) United States
(12) Patent Application Publication
(10) Pub. No.: US 2025/0277717 A1
(43) Pub. Date: Sep. 4, 2025

(54) NON-INVASIVE REAL-TIME MONITORING SYSTEM FOR MxN OPTICAL CIRCUIT SWITCH WITH MEMS MIRROR ARRAY BASED SWITCH ENGINE

(71) Applicant: Molex, LLC, Lisle, IL (US)

(72) Inventors: Gongjian Hu, Seaside, CA (US); Lifu Gong, San Jose, CA (US); Feng Qing Zhou, San Jose, CA (US)

(21) Appl. No.: 19/056,949

(22) Filed: Feb. 19, 2025

Related U.S. Application Data
(60) Provisional application No. 63/559,272, filed on Feb. 29, 2024.
(60) Provisional application No. 63/729,977, filed on Dec. 10, 2024.

(51) Int. Cl. G01M 11/00; G01M 11/02; G02B 26/08

(52) U.S. Cl. CPC G01M 11/005; G01M 11/0207; G01M 11/335; G02B 26/0833

(57) ABSTRACT

A system and method for monitoring an optical circuit switch device are provided. The system may include: a first light source that generates a first reference light beam; a first optical device that transmits light and reflects light; a first filter positioned between an input collimator array and a lens structure; the first filter receives the first reference light beam from the first optical device and passes the first reference light beam through a set of a first MEMS array and a second MEMS array; a first monitoring device that receives the first reference light beam that monitors at least a first mirror drift in a first MEMS array; and a second monitoring device that simultaneously receives a second reference light beam that monitors at least a second mirror drift in the second MEMS array.

### FIELD OF THE INVENTION

The present disclosure relates to the field of optical networks and, more particularly but not exclusively, to the field of micro-electro-mechanical systems (MEMS) mirror-based optical circuit switches and monitoring systems.

### BACKGROUND

Optical Circuit Switches (OCSs) or photonic cross-connects (PXCs) are at the heart of optical circuit switching networks. OCSs have provided benefits over non-switching optical networks or those optical networks having optical-electrical-optical transitions.

M×N OCS is an Optical Circuit Switch (OCS) that connects optical signals from any of the M input ports to any of the N output ports. Notably, M×N OCS devices are steadily replacing electrical packet switches in intra-data center connections. This may be attributed to improved capacity and low power consumption which are driven significantly by Artificial Intelligence (AI) networks.

In order to provide resilient network connection and switching services, a monitoring system is needed to detect performance degradation as well as faults during service.

Current solutions simply use optical power tapping with photodiodes (PDs) and associated electronics at every input port and every output port to monitor an optical loss change in the system. In response, switch engine operating parameters may be adjusted through a closed loop. However, current solutions require significant costs and resources as M+N sets of PDs and detection electronics are required. In addition, this leads to an additional loss due to two sets of tapping losses which further increase optical transceiver costs as high-end transceivers will be required to compensate for the extra tapping loss. Moreover, additional hurdles will be faced in other scenarios, such as dark switching, for example. Without an input port light, there is no signal on a PD monitor and MEMS mirror angle drift is unknown.

It would be desirable, therefore, to have a system and method that could overcome the foregoing disadvantages of known systems.

### SUMMARY

According to an embodiment, the disclosure relates to a monitoring system for an optical circuit switch device. The monitoring system comprises a first light source that generates a first reference light beam; a first optical device that transmits light and reflects light; a first filter positioned between an input collimator array and a lens structure; the first filter receives the first reference light beam from the first optical device and passes the first reference light beam through a set of a first MEMS array and a second MEMS array; a first monitoring device that receives the first reference light beam that monitors at least a first mirror drift in the first MEMS array; and a second monitoring device that simultaneously receives a second reference light beam that monitors at least a second mirror drift in the second MEMS array.

According to another embodiment, the monitoring system further comprises: a second light source that generates the second reference light beam; a second optical device that reflects light and transmits light; and a second filter positioned between an output collimator array and a second lens structure; the second filter receives the second reference light beam from the second optical device and passes the second reference light beam through the set of the second MEMS array and the first MEMS array.

According to an embodiment, the disclosure relates to a method for monitoring an optical circuit switch device. The method comprises the steps of generating, via a first light source, a first reference light beam; receiving, via a first filter positioned between an input collimator array and a lens structure, the first reference light beam from a first optical device that transmits light and reflects light; passing, via the first filter, the first reference light beam through a set of a first MEMS array and a second MEMS array; receiving, via a first monitoring device, the first reference light beam that monitors at least a first mirror drift in the first MEMS array; and simultaneously receiving, via a second monitoring device, a second reference light beam that monitors at least a second mirror drift in the second MEMS array.

According to an embodiment, the disclosure relates to a monitoring system for an optical circuit switch device. The monitoring system comprises a first collimator array with two or more input ports that receive test light beams from at least one test light source that generates the test light beams; a first MEMS array and a second MEMS array that receives the test light beams from the two or more input ports and directs the received test light beams to a second collimator array; a second collimator array that includes two or more output ports that receive the test light beams from the first MEMS array and the second MEMS array; and at least one test light detecting device connected to the two or more output ports that receive the test light beams, that monitors the optical circuit switch device.

According to an embodiment, the disclosure relates to a method for monitoring an optical circuit switch device. The method comprises generating, from at least one test light source, test light beams; receiving by a first collimator array with two or more input ports, the test light beams; passing, through the two or more input ports the test light beams through a first MEMS array and a second MEMS array; receiving, by two or more output ports of a second collimator array, the test light beams; receiving by at least one test light detecting device the test light beams; and measuring using the test light beams an insertion loss of the optical circuit switch device.

According to another embodiment, the method further comprises the steps of: generating, via a second light source, the second reference light beam; receiving, via a second filter positioned between an output collimator array and a second lens structure, the second reference light beam from a second optical device that reflects light and transmits light; and passing, via the second filter, the second reference light beam through the set of the second MEMS array and the first MEMS array.

These and other advantages will be described more fully in the following detailed description.

### BRIEF DESCRIPTION OF THE DRAWINGS

In order to facilitate a fuller understanding of the present disclosure, reference is now made to the attached drawings. The drawings should not be construed as limiting the present disclosure but are intended only to illustrate different aspects and embodiments of the disclosure.

FIG. 1 is an exemplary diagram of a monitoring system for an optical circuit switch (OCS), according to an embodiment of the present disclosure.

FIG. 2A is an exemplary diagram of a lens structure, according to an embodiment of the present disclosure.

FIG. 2B is an exemplary diagram of a monitoring system with a lens structure for an optical circuit switch (OCS), according to an embodiment of the present disclosure.

FIGS. 3A and 3B illustrate insertion loss, according to an embodiment of the present disclosure.

FIG. 4A is an exemplary diagram of a lens structure, according to an embodiment of the present disclosure.

FIG. 4B represents an exemplary graph that illustrates beam spot diameter on camera versus focal length of micro lens, according to an embodiment of the present disclosure.

FIGS. 5A and 5B illustrate relative light intensity according to an embodiment of the present disclosure.

FIGS. 6A and 6B are exemplary flowcharts for calibration and control, according to an embodiment of the present disclosure.

FIG. 7 is an exemplary flowchart for determining the insertion loss and its change of an OCS, according to an embodiment of the present disclosure.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. It will, however, be apparent to those skilled in the art that these concepts may be practiced without these specific details. In some instances, well-known structures and components are shown in block diagram form in order to avoid obscuring such concepts.

One or more embodiments are directed to an optical switching device that includes an Optical Circuit Switch (OCS) and one or more lenses configured within the optical switching device for focusing input and output signals. The lenses may represent field lenses or focusing lenses that may decrease the beam divergence angles and extend the Rayleigh length or range. The field lenses or focusing lenses may effectively reduce beam diffraction losses. The optical switching device may include collimator arrays for input and output signals, micro-electro-mechanical systems (MEMS) micro-mirror arrays (MEMS Arrays), and lenses coupled to the collimators that focus the signals on the MEMS arrays. Micro-mirror or mirror may be used interchangeably in the disclosure. According to one or more embodiments, the collimator may include a fiber array for receiving or transmitting optical signals at the optical switching device. An optical lens array may be aligned and optically coupled to the fiber array.

An embodiment is directed to a non-invasive real-time monitoring system that avoids having to use optical power tapping. According to an embodiment, the monitoring system may be implemented to support non-signal band wavelength light as a reference beam and then monitor its optical system coupling with monitoring devices, such as cameras. According to an exemplary illustration, the monitoring system may be used with an OCS with MEMS mirror array-based switch engines, as detailed in U.S. Pat. No. 11,506,884, the disclosure of which is incorporated by reference herein in its entirety. Other implementations and/or integrations with various other optical devices may be supported.

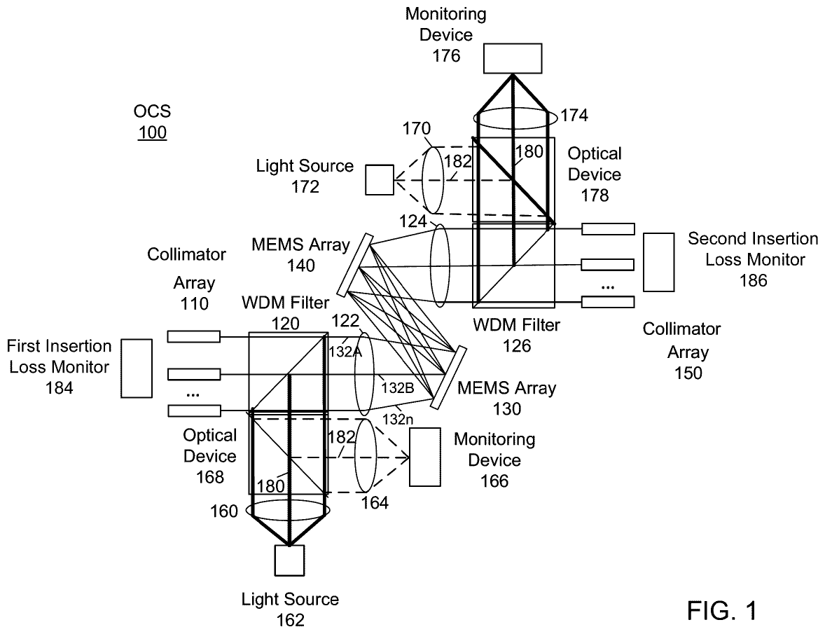

FIG. 1 is an exemplary diagram of a monitoring system for an optical circuit switch (OCS), according to one or more embodiments. The OCS 100 may be an all-optical switching matrix including input collimators, shown by Collimator Array 110, having m number of collimator elements, MEMS Array 130, including m number of micro-mirror elements, MEMS Array 140, including n number of micro-mirror elements, and an output collimator, shown by Collimator Array 150, having n number of collimator elements. For example, a collimator may narrow a beam or align the beam for output through the collimator.

The input collimator may include multiple collimators that may be coupled to an m number of optical fibers. Each of the optical fibers is coupled to a port in the input collimator. An input optical signal may enter through the ports of the input collimators through the optical fibers for transmission through the device, OCS 100. The signal transmitted through each optical fiber may include one or more optical wavelengths (λi). The output light from the output collimators, Collimator Array 150, (e.g., reaching the collimators 150 from collimators 110 via paths 132A, 132B, 132n) may be provided to a set of output optical fibers through a plurality of output ports, each carrying a signal at one or more optical wavelengths (λi).

The collimator arrays 110 and 150, in one or more embodiments, include a plurality of input and/or output ports. For example, in a non-limiting example, a collimator array, e.g., Collimator Array 110, may include 560 ports. Typically, only a percentage of ports, such as 512 ports, are needed; the remaining ports are either non-operational backup ports or may be used to determine insertion loss and its change.

A test light source, such as a coherent light source with the same wavelength of the signals, can be coupled to the input ports of the input Collimator Array 110. The test light is then received by the extra ports of the output Collimator Array 150 and passed to a light detector, such as but not limited to a photo-detector or camera, or other intensity detectors, to determine the level of insertion loss by comparing the test light source power and received light power. While some insertion loss is expected, if the detected level of insertion loss change is greater than a predetermined threshold, this may be an indication that the MEMS Arrays 130, 140 may need calibration or other problems are present in the OCS 100.

For example, in a non-limiting example, if the input Collimator Array 110 and output Collimator Array 150 each have seven hundred ports, one hundred forty may be defective for various reasons associated with the assembly and manufacturing of the Collimator Arrays 110, 150, or MEMS Arrays 130, 140; this results in five hundred and sixty useful ports. If the OCS 100 only requires 544 ports to function, there will be sixteen extra ports that can be used in one or more embodiments to determine insertion loss and its change for the OCS. These sixteen extra ports in one or more embodiments may be divided into two groups, resulting in measurements being taken from eight plus eight locations in two directions (from Collimator Arrays 110 to 150 and vice versa).

The collimator elements or ports of the Collimator Arrays 110, 150 may be separate individual collimators or combined into a collimator array. For example, the input and output collimators 110, 150 may be structurally similar. The MEMS Arrays 130, 140 may represent a MEMS-based micro-mirror array that may selectively direct optical beams from individual optical fibers coupled to the input collimators, Collimator Array 110, to selected optical fibers coupled to the output collimators, Collimator Array 150. The MEMS Arrays 130, 140 may include two sets of micro-mirror arrays each having an m and n number of micro-mirrors formed on a substrate. The micro-mirror arrays and their constituent elements may be referred to as opposing, facing, or adjacent elements. The substrate may serve as a foundation for the micro-mirror elements.

The state of each micro-mirror may be controlled by applying a voltage between two or more electrodes associated with each micro-mirror in the MEMS Arrays 130, 140. For example, by rotating the micro-mirrors in the MEMS Arrays 130, 140, a signal from any input fiber coupled to the input collimators, Collimator Array 110, may be passed to any output fiber coupled to the output collimators, Collimator Array 150. In some embodiments, the voltage may have a maximum value or may be limited such that the micro-mirrors have a maximum tilt angle or scanning range. One skilled in the art would recognize that control of the micro-mirrors may be affected by other mechanisms and forms of actuation including, for example, mechanical, electromagnetic, and/or chemical processes.

Those skilled in the art will readily recognize that other configurations of an OCS device or system may be possible. Any combination may be possible of the various collimator and micro-mirror arrangements including scaled collimator pitch, circular, hexagonal, and/or other micro-mirror arrangements based on user and other needs or preferences.

As shown in FIG. 1, OCS 100 may include two lenses 122, 124 used for focusing input and output beams to and from MEMS Arrays 130, 140, in accordance with one or more embodiments. OCS 100 may represent an all-optical switching matrix including input collimators, Collimator Array 110, including m number of collimator elements or ports, a MEMS Array 130 and a MEMS Array 140 that may be controlled to pass beams from any input collimator element of Collimator Array 110 to any output collimator element of Collimator Array 150.

The OCS 100 may include a lens element, shown by Lens 122, that has a focal point at MEMS Array 140. For example, the Lens 122 may have a focal point at the center or approximate center of MEMS Array 140. The OCS 100 may include a lens element, shown by Lens 124, that has a focal point at MEMS array 130. For example, the Lens 124 may have a focal point at the center or approximate center of MEMS Array 130. In the example of FIG. 1, Lens 124 may be configured to pass the beams such that the beams are normal to (or parallel to the direction of) the input at each respective collimator element or ports of the Collimator Array 150.

The input collimators, Collimator Array 110, may include multiple collimators that may be coupled to an m number of optical fibers. An input optical signal transmitted through each optical fiber may include one or more optical wavelengths (λi). Output light from the output collimators, Collimator Array 150, including collimator elements may be provided to a set of output optical fibers, each carrying a signal at one or more optical wavelengths (λi). Paths 132A, 132B, 132n may represent light or beam paths. Paths 132A, 132B, 132n may be a collimated beam from Collimator Array 110 passing through Lens 122 that focuses the beam towards the center or approximate center of MEMS Array 140.

The collimators may be separate individual collimators or combined into a collimator array. According to one or more embodiments, the input and output collimators, Collimator Array 110 and Collimator Array 150, may be structurally similar. The MEMS Array 130 may represent a MEMS-based micro-mirror array that may selectively direct optical beams from individual optical fibers coupled to the input collimators, Collimator Array 110, to selected optical fibers coupled to the output collimators, Collimator Array 150, via Lenses 122, 124.

The MEMS Arrays 130, 140 may include sets of micro-mirror arrays. The state of each micro-mirror may be biased by applying a voltage or electric charge between two or more electrodes associated with each micro-mirror in the MEMS Arrays 130, 140. In an unbiased state, no voltage may be applied to the micro-mirror. In a biased state, for example, by applying a voltage and rotating the micro-mirrors in the MEMS Arrays 130, 140, a signal from any input fiber coupled to the input collimators, Collimator Array 110, may be directed to any output fiber coupled to the output collimators, Collimator Array 150.

In the example of FIG. 1, a micro-mirror may be in an un-biased state (e.g., no voltage or charge is applied) such that the beam paths 132A, 132B, 132n are focused towards the center or approximate center of MEMS Array 140. With Lens 122, the beams may be directed to the entire MEMS Array 140 (e.g., any micro-mirror) biasing the micro-mirror through the full-scanning range.

Lenses 122 and 124 may be structurally similar and may include a matched set of lenses with similar properties. For example, the Lenses 122 and 124 may have the same or substantially similar focal length. The OCS 100 may be designed symmetrically with corresponding input and output elements of OCS 100 having a similar structure. For example, the MEMS Arrays 130 and 140 may be located at similar distances and offset angles from Lenses 122, 124, respectively. When elements of the OCS 100 share common attributes, the design and operation of the OCS 100 may be simplified. For example, control of the MEMS Arrays 130, 140 may be similar, with each array sharing a common control logic.

According to one or more embodiments, either or both Collimator Arrays 110, 150 may have collimator elements with regular pitch or scaled pitch. In another embodiment, either or both MEMS Arrays 130, 140 may have elements arranged in a pattern, such as a circular pattern, a hexagonal pattern, etc. For example, when the Collimator Arrays 110, 150 have scaled pitch and/or the MEMS Arrays 130, 140 have circular/hexagonal patterns, the OCS 100 may be designed in a smaller package. In some embodiments, when the Collimator Arrays 110, 150 have scaled pitch and/or the MEMS Arrays 130, 140 have circular/hexagonal patterns, the OCS 100 may be designed with a larger number of micro-mirror elements m and n than one without either or both of the pitched and circular/hexagonal patterns. With Lenses 122, 124, an OCS specified with a given maximum micro-mirror voltage may be designed with a larger port count. In addition, an OCS may be designed in a smaller physical package for the same number of input/output ports.

While the Lenses 122, 124 are illustrated as positive powered lenses, one skilled in the art will readily recognize that the lenses may take various forms, including prisms, negative powered lenses, etc. In addition, other embodiments may employ passive and/or active elements.

Several aspects of optical switching systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

According to one or more embodiments, OCS 100 may include Collimator Array 110 that outputs optical signal light through Lens 122. Focused light may then be received by MEMs Array 130 and MEMs Array 140, the output of which is received by Lens 124 and transmitted to Collimator Array 150.

Collimator Array 110 and Collimator Array 150 may output every optical signal light from any port of input ports into a collimated beam and couple any incoming beam into a specific output fiber of output ports.

Lens 122 may represent an Achromatic Field Lens that focuses incoming signal beams into the center of the second MEMS Array 140. Achromatic Field Lens 122 may relay the incoming signal beams' waist to a position that is located between MEMS Array 130 and MEMS Array 140. Based on focusing incoming signal beams, Achromatic Field Lens 122 may magnify MEMS mirror array pitch relative to the Collimator Array 110 so that the Collimator Array pitch may be enlarged and each collimator in Collimator Array 110 may be adjusted as desired. By enlarging the pitch, one or more embodiments facilitate and improve the manufacture of the collimator. This is in contrast to current solutions where the MEMS mirror array pitch and collimator array pitch are both small which results in a complex manufacturing process.

Each mirror in MEMS Array 130 may steer the incoming signal beam to any one mirror in MEMS Array 140. Each mirror in MEMS Array 140 may steer the incoming beam to any one of the output collimator arrays of Collimator Array 150.

One or more embodiments are directed to a Monitoring System for the OCS device 100. The Monitoring System may include Wavelength Division Multiplexer (WDM) filters, Optical Devices (e.g., beam splitters, Polarizing Beam Splitter (PBS), filters), Collimated Reference Light Sources, and Cameras (or other monitoring devices).

As shown in FIG. 1, WDM Filter 120 may be positioned between an input collimator, as shown by Collimator Array 110, and Lens 122. WDM Filter 126 may be positioned between Lens 124 and an output collimator, as shown by Collimator Array 150.

WDM Filters 120, 126 may combine and separate signal wavelength band beams with a monitoring reference beam that uses an out-of-signal band wavelength. For example, a monitoring reference beam may have an 800-900 nm wavelength while the signal band may be within O band, C band, L band, or E band. Other signal bands that do not conflict with the monitoring reference beam band may be supported.

WDM Filters 120, 126 may be transparent for all signal wave bands and include a high reflector for a monitoring reference wavelength. Notably, a WDM filter is not needed between the two MEMS Array, as shown by MEMS Array 130 and MEMS Array 140. One or more embodiments may use two WDM filters only. According to one or more embodiments, the WDM Filters 120, 126 are configured outside of the MEMS Arrays 130, 140 (e.g., the optical paths of light traveling between the MEMS Arrays 130, 140). In addition, one or more embodiments may be absent of mirrors outside of the MEMS Array 130 and MEMS Array 140.

One or more embodiments monitor a first single collimated light from the first end to a second end and simultaneously monitor a second single collimated light from the second end to the first end. The WDM Filter combines a signal path and a reference light in the OCS device. With one or more embodiments, a reference light is combined with the signal beam from the input collimator, transmitted through the MEMS arrays, and then separated to be received by a monitoring device, such as a camera, while the signal beam goes through the output collimator. One or more embodiments detect and monitor the combination effect of the stability of the optical system passing the signal beam and drifts of MEMS mirrors in the signal beam path using the reference light.

Optical Devices 168, 178 may represent beam splitters, such as 50/50 beam splitters (or other ratio of power splitting), that multiplex/de-multiplex two monitoring reference beams with any polarization state. In this example, Optical Devices 168, 178 each allow a first reference light to pass through while it reflects a second reference light with some power reduction according to its splitting ratio, e.g., 3 decibels (dB) if 50/50.

Optical Devices 168, 178 may also represent PBSs that multiplex/de-multiplex two monitoring reference beams with polarization directions perpendicular to each other. In this example, Optical Devices 168, 178 each allow a first reference light in one polarization (p) to pass through while it reflects a second reference light in the orthogonal polarization(s).

Optical Devices 168, 178 may also represent filters, such as coarse wavelength division multiplexer (CWDM) filters. In this example, Optical Devices 168, 178 each allows a first reference light in one wavelength to pass through while it reflects a second reference light in another wavelength. Optical Devices 168, 178 may also represent other optical devices, such as couplers, circulators, etc.

As shown in FIG. 1, WDM Filter 120 may receive a first Reference Light beam 180 from Light Source 162 through Optical Device 168. The first Reference Light beam 180 passes through WDM Filter 120 and WDM Filter 126 and is received and captured by Monitoring Device 176 through Optical Device 178.

The first Reference Light Beam 180 may monitor the combination of a mirror drift in the first MEMS Array 130 and a mirror drift in a second MEMS Array 140, with a much higher monitoring sensitivity on the mirror drift in the first MEMS Array 130. The first Reference Light Beam 180 travels in the upstream direction.

In a similar manner, WDM Filter 126 may receive a second Reference Light beam 182, shown in dashed lines, from Light Source 172 through Optical Device 178. The second Reference Light beam 182 passes through WDM Filter 126 and WDM Filter 120 and is received and captured by Monitoring Device 166 through Optical Device 168.

The second Reference Light Beam 182 may monitor the combination of a mirror drift in a second MEMS Array 140 and a mirror drift in a first MEMS Array 130, with a much higher monitoring sensitivity on the mirror drift in the second MEMS Array 140. The second Reference Light Beam 182 travels in the downstream direction.

Collimated Reference Light Sources, shown by Light Sources 162, 172, as well as any test light sources included in the first insertion loss monitor 184 and second insertion loss monitor 186, may each include an LED (light-emitting diode), a laser (such as VCSEL (Vertical Cavity Surface Emitting Laser)), FP (Fabry-Perot Laser), DFB (Distributed Feedback Laser), or other component that produces light.

Collimated Reference Light Sources may include a lens or a group of lenses 160, 170 to collimate laser light into OCS system and illuminate the whole MEMS Array 130 or MEMS Array 140. The lens design may be determined by Numerical Aperture (NA) of laser light beam and system field of view (FOV) size. One or more embodiments recognize that a larger port count of the OCS results in a larger FOV size. For example, a 700×700 OCS may have an approximate FOV size of 80×80 mm.

Collimated Reference Light Source, shown by Light Source 162, transmits a reference light beam and travels upstream to reach mirrors in MEMS Array 130, and corresponding movement may be monitored by Monitoring Device 176. In a similar manner, Collimated Reference Light Source, shown by Light Source 172, transmits a reference light beam to reach mirrors in MEMS Array 140, and corresponding movement may be monitored by Monitoring Device 166.

The first insertion loss monitor 184 and second insertion loss monitor 186 may comprise one or more collimated light sources and may comprise an LED, a laser (such as VCSEL), FP, DFB, or other component that produces light. Test insertion loss monitors, e.g., 184 and 186, may comprise of a single light source or as many light sources as there are extra ports in the Collimator Array 110. In one or more embodiments, test insertion loss monitors, e.g., 184 and 186, may comprise three light sources, two of which are combined and coupled to the extra ports in the Collimator Array 110 and one of which is a backup. The test insertion loss monitors, e.g., 184 and 186, may have the same wavelength, a similar wavelength, or a wavelength within the range of that of the signal light used during the normal operation of the OCS 100.

Monitoring Devices 166, 176 may each include a lens or a group of lenses 164, 174 and an optical sensor array. The optical sensor array may include a CCD (charge-coupled device), CMOS (complementary metal oxide semiconductor), or other type of sensor. The optical sensor array may be positioned at the image plane of the lens so that the monitoring device (e.g., camera) may directly monitor one or more focused beam spots.

For example, Monitoring Device 176 may monitor collimated reference light beam 180 at each mirror of MEMS Array 130. The MEMS mirror tilting drift from its nominal position may result in focused beam spots on different positions (e.g., pixels) of a sensor of Monitoring Device 176. Simultaneously, Monitoring Device 166 may monitor collimated Reference Light Beam 182 at each mirror of MEMS Array 140. The MEMS mirror tilting drift from its nominal position may result in focused beam spots on different positions (e.g., pixels) of a sensor of Monitoring Device 166. The monitoring of Monitoring Device 166 and Monitoring Device 176 may occur simultaneously, near simultaneously, sequentially, or at other intervals.

Test insertion loss monitors, e.g., 184 and 186, may each include an optical sensor array. The test insertion loss monitors, e.g., 184 and 186, may include one or more photodiodes, a CCD (charge-coupled device), CMOS (complementary metal oxide semiconductor), or another type of sensor. Alternatively, the first insertion loss monitor 184 may only be a test light source, and the second insertion loss monitor 186 may only be an optical sensor array, or the first insertion loss monitor 184 may only be an optical sensor array, and the second insertion loss monitor 186 may only be a test light source.

The test insertion loss monitors, e.g., 184 and 186, may receive test light produced by the opposite test insertion loss monitors, e.g., 184 and 186, from one or more extra ports of the input Collimator Array 110 and/or output Collimator Array 150. In operation, combined with the test insertion loss monitors', e.g., 184 and 186, power measurement, the test insertion loss monitors, e.g., 184 and 186, may measure the insertion loss change of the OCS 100; this insertion loss change may occur because of problems with the first and second MEMS Arrays 130, 140, the first and second Collimator Arrays 110, 150, or any other part of the OCS 100. When the insertion loss change is greater than a predetermined threshold that is set by a manufacturer or user, initially the mirrors forming the MEMS Arrays 130, 140 may be reset to a calibration setting and may be tested utilizing the Light Sources 162 and 172 and Monitoring Devices 166 and 176 to re-calibrate the MEMS Arrays 130 or 140. If this still does not result in an acceptable insertion loss, then appropriate changes to other components may be made, or the user or manufacturer may be alerted that the OCS 100 is not functioning correctly.

With the Field Lens, e.g., 122, focusing the input beam, MEMS mirror (positive and negative) steering angle are more fully used to support additional port counts. By implementing a Field Lens, e.g., 122, the OCS device is able to support a larger number of ports. One or more embodiments recognize that the number of ports is dependent on the tilting angle of the MEMS array. A bigger angle, however, adds to the complexity of designing the MEMS array. The MEMS array generally has a tilt angle between +/−a (for example, +/−5) degrees. Current solutions are limited to zero to +a (for example, +5) on one side and −a (for example −5) to zero on another side, so they are unable to fully utilize the MEMs array. By using a Field Lens, e.g., 122, one or more embodiments are able to utilize an entire range of +a to −a (for example +5 to −5) degrees of tilting capability. This may support a larger number of ports with an increase of a multiple of four, for example.

According to one or more embodiments, the monitoring devices may monitor the collimated beams where a high angle resolution of 1/1000 degree may be achieved. Each monitoring device or camera may monitor the tilting positions of the combination of the two MEMS arrays with a much higher monitoring sensitivity on the MEMS array at the far end. A pixel area may represent an image of a specific combination of two mirrors in pair from two MEMs arrays illuminated by the reference light where the light intensity of the pixel area may be monitored by the monitoring device.

The monitoring system of one or more embodiments may be placed outside of the field lenses (e.g., not placed between field lenses). With this configuration, the light beams are close to telecentric and are approximately normal to the monitoring device which provides a better resolution and improved accuracy.

Each monitoring device 166, 176 may monitor both MEMS Arrays 130, 140. Using the results of the monitoring, the MEMS Arrays 130, 140 may then be controlled with a control algorithm by each monitoring device or any other component or controller. With the monitoring configuration, the bottom Monitoring Device 166 is more sensitive to detect motion on MEMS Array 140, and the top Monitoring Device 176 is more sensitive to detect motion on MEMS Array 130. The results from each of the Monitoring Devices 166, 176, may be combined, and a predetermined weight may be applied, or the individual results from each monitoring device 166, 176 may be used to determine an offset. When an offset is detected by one or both Monitoring Devices 166, 176, commands may be issued to control or adjust either or both MEMS Arrays. For example, the bottom Monitoring Device 166 may issue a command to the MEMS Array 140, and the top Monitoring Device 176 may issue a command to MEMS Array 130. The MEMS Arrays 130, 140 may be controlled to then optimize the positions. Even when there is no input port light, the monitoring devices may still monitor the reference light so that the optimized angle tilt-Y and tilt-X of both MEMS mirrors may be monitored and maintained.

One or more embodiments are directed to a holistic monitoring of an OCS system as opposed to conventional independent monitoring. For example, the monitoring system may monitor a combination of input MEMS tilting angles and output MEMS tilting angles. The input monitoring is more heavily dependent on the input MEMS array, e.g., 90% input MEMS and 10% output MEMS. The output monitoring is more dependent on the output MEMS array, e.g., 90% output MEMS and 10% input MEMs. One or more embodiments are directed to monitor the tilting angles of the input and output MEMS arrays in addition to the relative movement between the two MEMS arrays. For example, an upstream beam spot shift (Yu) is monitored as well as a downstream beam spot shift (Yd). Based on known system parameters (e.g., a gap between MEMS Arrays (z1), a gap between a Field Lens and a MEMS Array (z2)), MEMS mirror drift angles a1 and a2 may be determined. With respect to FIG. 1, z1 represents the distance between MEMS Arrays 130 and 140; z2 represents a gap between Field Lens 122 and MEMS Array 130 as well as a gap between Field Lens 124 and MEMS Array 140; a1 represents a mirror drift angle for MEMS Array 130; a2 represents a mirror drift angle for MEMS Array 140.

$$Yu = ( z 1 + z 2 ) * a 1 + z 2 * a 2 \\ Yd = ( z 1 + z 2 ) * a 2 + z 2 * a 1$$

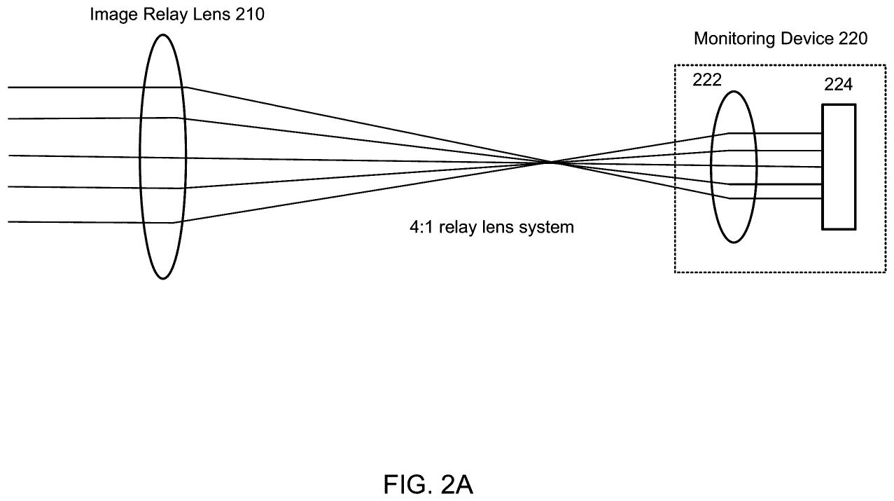

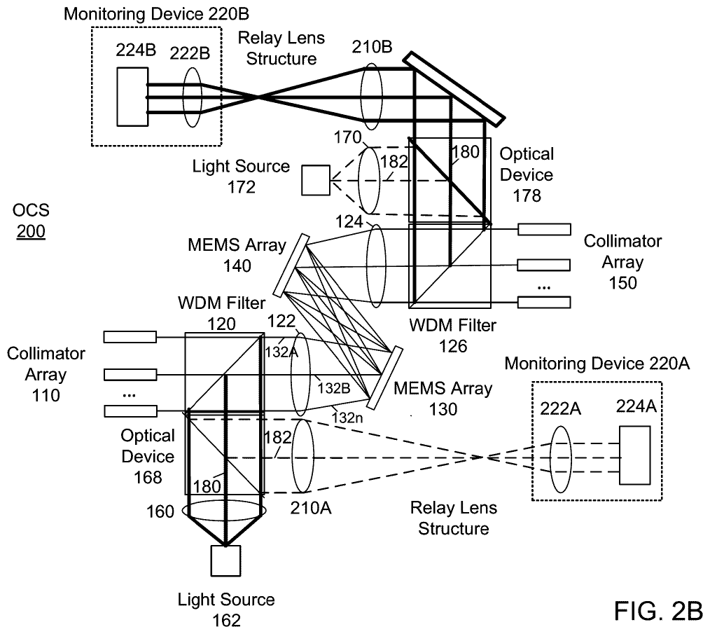

FIG. 2A is an exemplary diagram of a lens structure, according to one or more embodiments. The Monitoring System may include an additional lens structure with an Image Relay Lens 210 that focuses light beams to a Monitoring Device 220. The Monitoring Device 220 may include a Lens 222 and a Sensor Array 224. The Lens 222 may include a group or array of lenses.

FIG. 2B is an exemplary diagram of a monitoring system with a lens structure for an optical circuit switch (OCS), according to one or more embodiments. As shown in FIG. 2B, OCS 200 includes Relay Lens Structures as shown by 210A and 210B. Monitoring Device 220A includes Lens 222A and Sensor Array 224A. In a similar manner, Monitoring Device 220B includes Lens 222B and Sensor Array 224B.

As shown in FIG. 2B, Optical Devices 168, 178 may represent beam splitters, such as PBS, 50/50, as well as filters, such as CWDM filters. According to an exemplary illustration, Optical Devices 168, 178 may represent CWDM filters. In this example, the system may implement VCSEL (as Light Source 162) having a wavelength of 0.85 μm for an upstream optical path, and VCESL (as Light Source 172) having a wavelength of 0.9 μm for a downstream optical path. CWDM filters (as Optical Devices 168, 178) may pass 0.85 μm wavelength light and reflect 0.9 μm wavelength light. Monitoring Device 220B may detect 0.85 μm light and Monitoring Device 220A may detect 0.9 μm light.

According to an exemplary illustration, Optical Devices 168, 178 may represent PBSs. In this example, the system may implement VCSEL (as Light Source 162) having a P polarization state for an upstream optical path and VCESL (as Light Source 172) having an S Polarization state for a downstream optical path. PBSs (as Optical Devices 168, 178) may pass P polarization light and reflect S polarization light. Monitoring Device 220B may detect P polarization light and Monitoring Device 220A may detect S polarization light. According to another example, Optical Devices 168, 178 may represent beam splitters in 50/50 or other power splitting ratios. In this example, the system may implement VCSELs as Light Sources 162, 172, where a VCSEL beam for upstream and downstream paths may pass the beam splitters twice. In this scenario, only partial (for example, 25% if 50/50) reference beam power may reach each monitoring device. However, there is no restriction of a specified polarization or wavelength of light source. This supports a lower cost benefit.

One or more embodiments recognize that a system with a large FOV size may require additional resources to support a monitoring device, such as a camera with a large FOV. One or more embodiments are directed to implementing a set of relay lenses into the OCS system with the power of N:1 to reduce FOV to 1/N in each direction. This enables the ability to use smaller camera systems with smaller sensors without sacrificing performance.

For example, a 700×700 OCS, in accordance with one or more embodiments, may have a corresponding FOV size of 80×80 mm. By implementing a 4:1 relay lens system, the FOV size may be reduced to 20×20 mm.

With an achromatic field lens system, monitoring reference beams may be parallel to a primary axis hitting the relay lens. Each beam image centered on a sensor plane may correspond to a specific section of a first collimated reference light beam (180) or a specific section of a second collimated reference light beam (182) carved out by paired mirrors of two MEMS Arrays to be monitored which facilitates the ability to track its shift on the image plane as the beams are linear.

For example, an initial reference beam spot's diameter of 800 μm may be determined by paired mirrors of MEMS Array 130 and MEMS Array 140. The beam diameter may be 200 μm after integrating a 4:1 relay lens which may cover approximately 1,500 pixels of the sensor (e.g., pixel size 4.5 μm). An OCS controller may then determine the beam center at a sensor based on a beam intensity profile measured by pixels of the sensor.

With conventional systems, the monitoring beams may be tilted with different angles per different MEMS mirror pair where a beam shift is not linear and may further require a camera monitor diffuser. Accordingly, if a diffuser is used on an image plane, the system resolution may be limited by the diffuser.

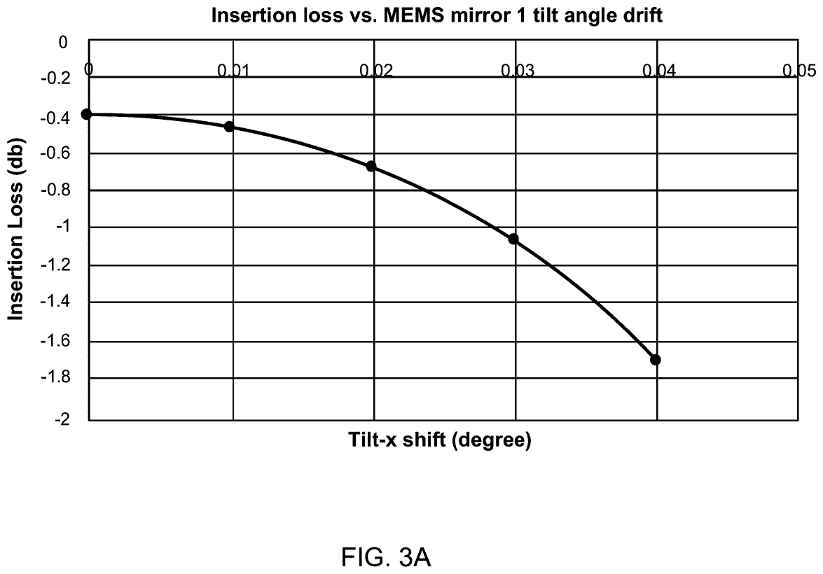

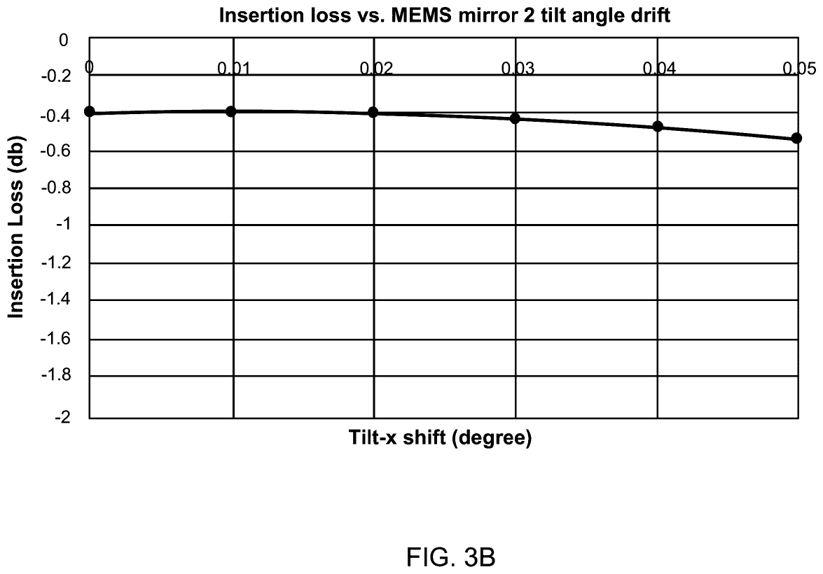

FIGS. 3A and 3B represent exemplary graphs that illustrate system sensitivity performance, according to one or more embodiments.

FIG. 3A illustrates insertion loss (in dB) versus tilt-x shift (in degrees), which represents the first MEMS mirror tilt angle drift. Insertion loss may represent a portion of a light beam that cannot be coupled to an output port. In the Y direction, a neighbor port's angle separation is approximately 0.39 degrees. In the X direction, a neighbor port's angle separation is approximately 0.5 degrees.

FIG. 3B illustrates insertion loss (in dB) versus tilt-x shift (in degrees) which represents a second MEMS Array tilt angle drift.

For a 0.1 dB Insertion Loss change, the first MEMS Array mirror allowed tilt angle shift is approximately 0.01 degrees and the second MEMS Array mirror allowed tilt angle shift is 0.04 degrees.

The monitoring device, such as a camera, may detect a reference beam image center drift at one pixel (4.5 μm) shift. Accordingly, one or more embodiments may support an angle sensitivity of 1/1000 degree.

An exemplary sensor may include a CMOS sensor. For example, the CMOS sensor may have an active area of 23.04 mm×18.432 mm and an image size of 20 mm×18.25 mm. This is one example for illustration purposes only. One or more embodiments may utilize other sensors including other CMOS sensors.

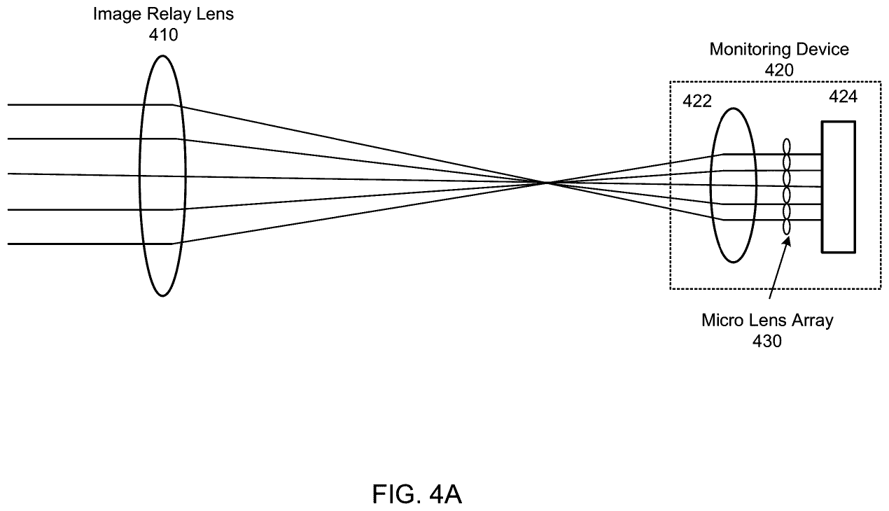

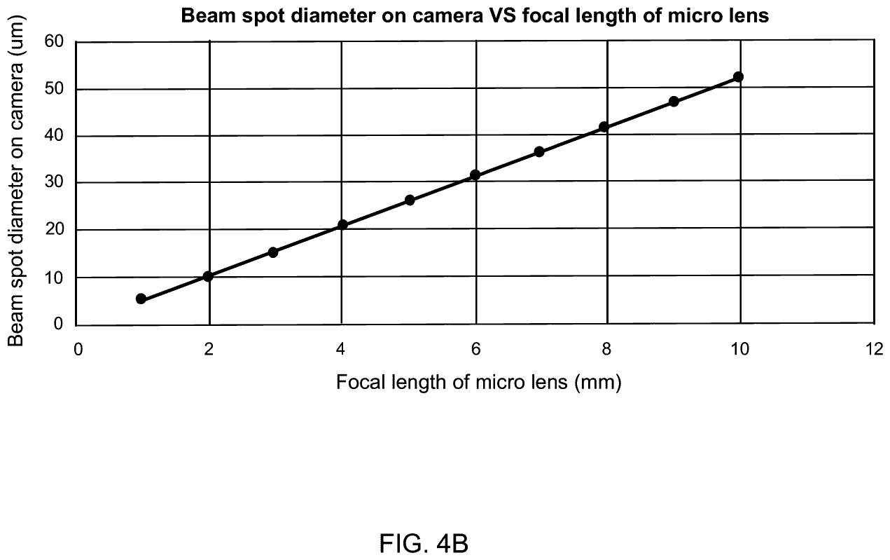

FIG. 4A is an exemplary diagram of a lens structure, according to one or more embodiments. The Monitoring System may include an additional lens structure with an Image Relay Lens 410 that focuses light beams to a Monitoring Device 420. The Monitoring Device 420 may include a Lens 422 and a Sensor Array 424. The Lens 422 may include a group or array of lenses.

One or more embodiments are directed to a Micro Lens Array 430 that increases monitor image sensitivity. The Micro Lens Array 430 may be added before a sensor, as shown by Sensor Array 424, in the Monitoring Device 420. The Micro Lens Array 430 may be integrated in Monitoring Devices 220A and 220B in OCS 200, as shown in FIG. 2B.

By adding Micro Lens Array 430 in between camera lens, shown as Lens 422 and sensor, shown as Sensor Array 424, one or more embodiments may further reduce the beam size on the sensor. This configuration increases the beam intensity to facilitate the controller's ability to identify a beam center, and further improves sensitivity and reliability of the monitoring system.

For example, Micro Lens Array 430 may be designed to match the beam chief rays shaped by mirrors of MEMS Array 130 and MEMS Array 140.

According to an exemplary illustration, the beam spot diameter on a camera sensor may be represented as 200 μm without the Micro Lens Array. With the Micro Lens Array 430, the beam spot diameter may be reduced, and beam intensity may be increased. For example, the lens array focus length may be designed as being between 1 to 10 mm. Accordingly, calculation time may be further reduced with a small number of pixels.

FIG. 4B represents an exemplary graph that illustrates the beam spot diameter on a camera versus the focal length of the micro lens, according to one or more embodiments. As shown in FIG. 4B, a beam spot diameter on a camera (in μm) is compared to a focal length of a micro lens (in mm). FIG. 4B illustrates a corresponding beam diameter on a camera sensor. To reduce the beam spot diameter and improve sensitivity, the shorter focal length of the micro lens may be used.

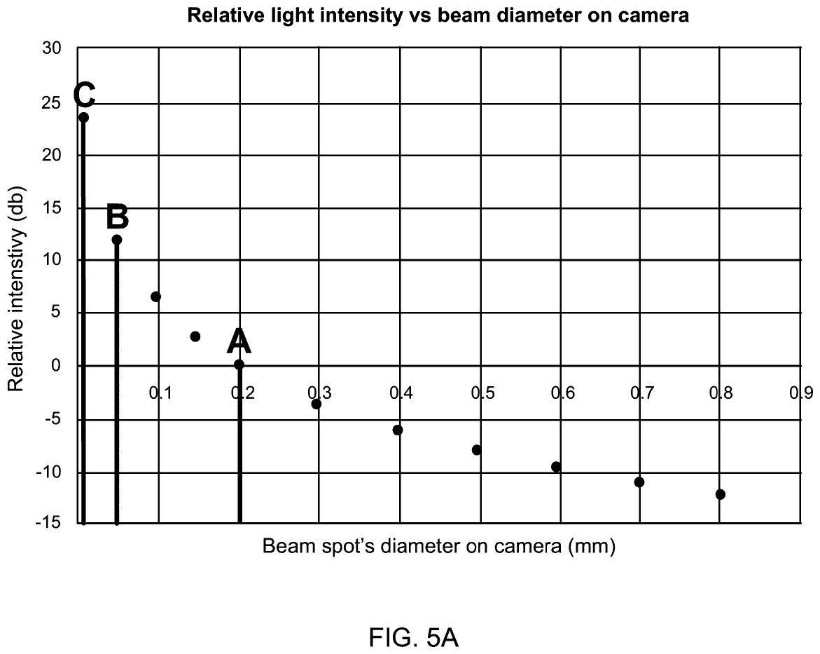

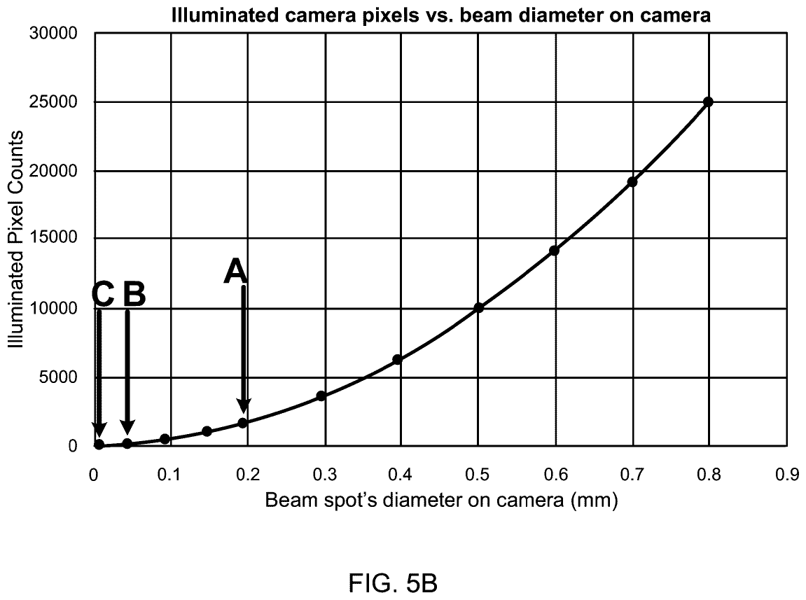

FIGS. 5A and 5B represent exemplary graphs that illustrate image sensitivity, according to one or more embodiments. One or more embodiments are directed to increasing image sensitivity by adding a Micro Lens Array, e.g., 430, before a Sensor, as illustrated in FIG. 4A above.

FIG. 5A illustrates relative light intensity versus beam diameter on the camera. FIG. 5A compares relative intensity (in dB) and a beam spot's diameter on the camera (in mm). Point A represents zero relative intensity and a corresponding beam spot's diameter of 0.2 mm. Point B represents 12 dB relative intensity and a corresponding beam spot's diameter of 0.05 mm. Point C represents 24 dB relative intensity and a corresponding beam spot's diameter of 0.01 mm.

FIG. 5B illustrates illuminated camera pixels versus a beam diameter on a camera. FIG. 5B compares illuminated pixel counts and beam spot's diameter on camera (in mm). Point A represents illuminated pixel counts of approximately 1500 and a corresponding beam spot's diameter of 0.2 mm. Point B represents illuminated pixel counts of ˜89 and a corresponding beam spot's diameter of 50 μm. Point C represents illuminated pixel counts of ˜3 and a corresponding beam spot's diameter of 10 μm.

By adding the Micro Lens Array, e.g., 430, in between the camera lens and a sensor, one or more embodiments may further reduce the beam size on the sensor and thereby increase the beam intensity for a controller to easily identify a beam center. Accordingly, this configuration improves the monitoring system's sensitivity and reliability.

Without a micro lens array, a beam diameter on the camera may be 200 μm, where the beam illuminates approximately 1500 pixels (where pixel size is represented as 4.5 μm).

In one or more embodiments with the micro lens array, a focal length is 10 mm, and the beam spot's diameter may be represented as approximately 50 μm on the camera, where the beam illuminates approximately 89 pixels. A relative signal intensity may increase to 12 dB.

In one or more embodiments with the micro lens array, a focal length is 1 mm, and the spot's diameter may be represented as approximately 10 μm on the camera where the beam illuminates approximately 3 pixels. A relative signal intensity may increase to 24 dB.

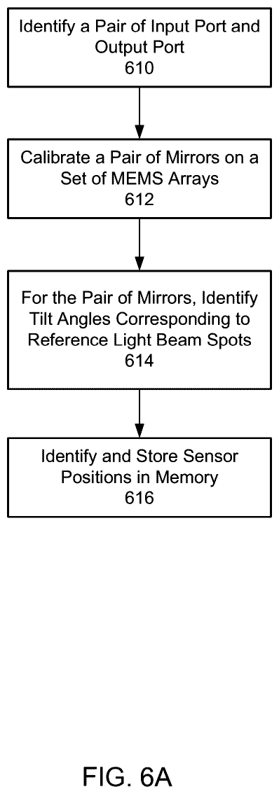

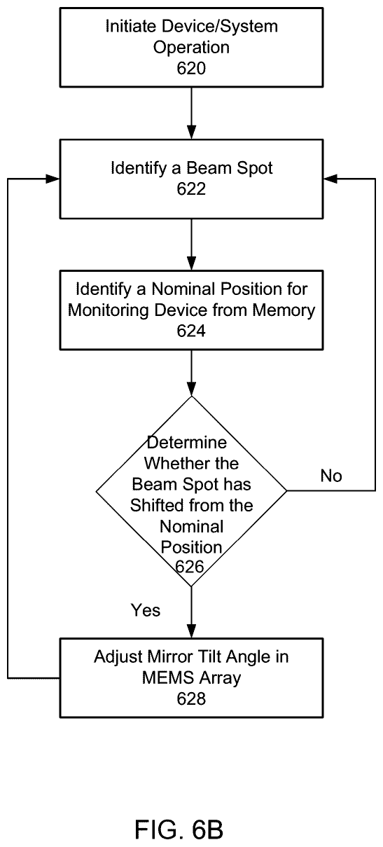

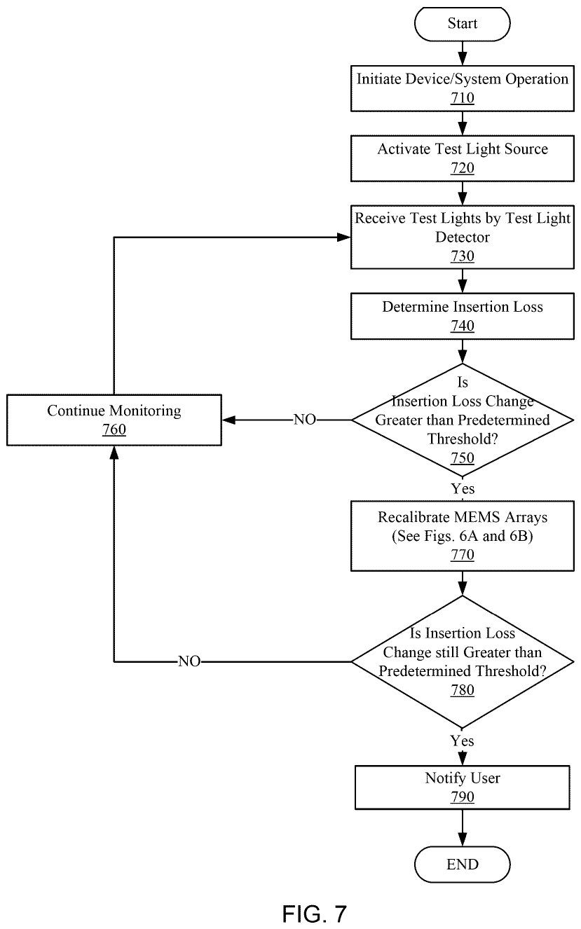

FIGS. 6A and 6B are exemplary flowcharts for calibration and control, according to one or more embodiments. One or more embodiments are directed to a monitor system calibration and control algorithm and system.

For any pair of the input port to output port connections, a specific pair of mirrors on MEMS Arrays 130 and 140 may be calibrated to optimize mirror tilting angles by corresponding reference light-focused beam spots to nominal sensor positions on Monitoring Devices 176 and 166. These positions are then stored in the memory of the control unit.

At step 610 in FIG. 6A, a pair of input port and output port combinations may be identified. At step 612, a pair of mirrors on a set of MEMS Arrays may be calibrated. At step 614, for each pair of mirrors on the MEMS Arrays, mirror tilting angles that correspond to reference light beam spots may be identified. At step 616, the corresponding sensor positions may be identified and stored in memory.

During operation, if a control unit identifies that a beam spot has shifted from its nominal position on Monitoring Device 176, the control unit may automatically adjust the mirror tilting angle on MEMS Array 130 to bring it back in a closed-loop control manner.

In a similar manner, during operation, if the control unit identifies that a beam spot has shifted from its nominal position on Monitoring Device 166, the control unit may automatically adjust the mirror tilting angle on MEMS Array 140 to bring it back in a close loop control manner.

At step 620 in FIG. 6B, the OCS device or system operation may be initiated. At step 622, a beam spot may be detected and identified by corresponding monitoring devices, such as cameras. At step 624, the nominal position for each monitoring device may be identified or otherwise retrieved from memory. At step 626, one or more embodiments may determine whether the beam spot has shifted or become misaligned from the identified nominal position. If not, the system may continue to monitor the beam spot at step 622. If yes, the system may automatically adjust the mirror tilt angle in the MEMS Array until alignment is achieved at step 628.

FIG. 7 is an exemplary flowchart for determining the insertion loss change of an OCS according to one or more embodiments. One or more embodiments are directed to OCS 100, which includes a system for determining insertion loss change and performing actions to correct it.

At step 710 in FIG. 7, the OCS device or system operation may be initiated. At step 720, at least one test light source is activated, producing test light beams. These test light beams are received by a first collimator array with two or more input ports. In one or more embodiments, a coupler may combine the light from more than one test light source and couple it to the two or more input ports. From the collimator array, the test light beams are passed to a first MEMS array and a second MEMS array, which direct the received test light beams, as well as any modulated light beams used for the normal operation of the OCS, to the second collimator array.

At step 730, the test light beams are received from the second collimator array and are directed to at least one test light-detecting device that is connected or coupled to two or more output ports of the second collimator array. At step 740, insertion loss change is determined for the OCS device.

The insertion loss change is compared to a predetermined threshold in step 750. The predetermined threshold may be any percentage or measurement of insertion loss change that a user or manufacturer determines is significant enough to require corrective actions. In general, some level of insertion loss change is acceptable due to tolerances in the various components of the OCS.

If the insertion loss change is determined in step 750 to be less than the predetermined threshold, the system continues to monitor the insertion loss change of the OCS in step 760 and steps 730-370 are repeated until the OCS is deactivated, or the monitoring is stopped for any other reason. Steps 730-760 may be performed continuously or on a periodic schedule. For example, if it is determined that changes usually occur over a time period of hours, it may be desirable to repeat steps 730-760 every half hour. Steps 730-760 may be performed more often or less often depending on user preference, material tolerances, design considerations, and any other considerations, and the method of FIG. 7 is not limited to the previous example.

If, however, the insertion loss change is greater than the predetermined threshold in step 705, the MEMS arrays are placed in calibration mode in step 770. This recalibration can be done as described in FIGS. 6A and 6B above or using any other useful method.

Once the MEMS arrays are calibrated in step 770, the insertion loss change is again determined, and in step 780, it is determined if the insertion loss change is still greater than the predetermined threshold. If still greater than the predetermined threshold, a user or other concerned party may be notified in step 790. Alternatively, other corrective actions may be taken in step 790 to reduce the insertion loss below the predetermined threshold. If, instead, at step 780, it is determined that the insertion loss is now less than the predetermined threshold, the method returns to step 760, where monitoring is continued.

It is understood that the specific order or hierarchy of steps in the processes disclosed is an illustration of exemplary approaches. Based on design preferences, it is understood that the specific order or hierarchy of steps in the processes may be rearranged. Further, some steps may be combined or omitted. The accompanying method claims to present elements of the various steps in a sample order and is not meant to be limited to the specific order or hierarchy presented.

The following provides an overview of aspects of the present disclosure:

Aspect 1: A monitoring system for an optical circuit switch device, the monitoring system comprising: a first light source that generates a first reference light beam; a first optical device that transmits light and reflects light; a first filter positioned between an input collimator array and a lens structure; the first filter receives the first reference light beam from the first optical device and passes the first reference light beam through a first MEMS array and a second MEMS array; a first monitoring device that receives the first reference light beam that monitors at least a first mirror drift in the first MEMS array; and a second monitoring device that simultaneously receives a second reference light beam that monitors at least a second mirror drift in the second MEMS array.

Aspect 2: The monitoring system of aspect 1, wherein the first light source comprises a collimated reference light source

Aspect 3: The monitoring system of any of aspects 1 through 2, wherein the first optical device comprises one of: PBS, beam splitter, WDM filter, coupler, and circulator.

Aspect 4: The monitoring system of any of aspects 1 through 3, wherein the first monitoring device monitors a first combination of the first mirror drift in the first MEMS array and the second mirror drift in the second MEMS array; and wherein the second monitoring device simultaneously monitors a second combination of the second mirror drift in the second MEMS array and the first mirror drift in the first MEMS array.

Aspect 5: The monitoring system of aspect 4, wherein the first monitoring device has a higher monitoring sensitivity for mirror drift of the first MEMS array; and wherein a relative position drift between the first MEMS array and the second MEMS array is monitored.

Aspect 6: The monitoring system of any of aspects 1 through 5, wherein the first light source comprises one of: LED, VCSEL, FP, and DFB.

Aspect 7: The monitoring system of any of aspects 1 through 6, wherein the lens structure comprises an achromatic field lens that focuses an incoming signal beam into a center of the second MEMS array.

Aspect 8: The monitoring system of any of aspects 1 through 7, wherein the first monitoring device comprises an image relay lens structure, a camera lens, and a sensor array.

Aspect 9: The monitoring system of aspect 8, wherein the first monitoring device further comprises a micro lens array configured between the camera lens and the sensor array.

Aspect 10: The monitoring system of any of aspects 1 through 9, further comprising: a second light source that generates the second reference light beam; a second optical device that reflects light and transmits light; and a second filter positioned between an output collimator array and a second lens structure; the second filter receives the second reference light beam from the second optical device and passes the second reference light beam through the second MEMS array and the first MEMS array.

Aspect 11: A method for monitoring an optical circuit switch device, the method comprising: generating, via a first light source, a first reference light beam; receiving, via a first filter positioned between an input collimator array and a lens structure, the first reference light beam from a first optical device that transmits light and reflects light; passing, via the first filter, the first reference light beam through a first MEMS array and a second MEMS array; receiving, via a first monitoring device, the first reference light beam that monitors at least a first mirror drift in the first MEMS array; and simultaneously receiving, via a second monitoring device, a second reference light beam that monitors at least a second mirror drift in the second MEMS array.

Aspect 12: The method of aspect 11, wherein the first light source comprises a collimated reference light source.

Aspect 13: The method of any of aspects 11 through 12, wherein the first optical device comprises one of: PBS, beam splitter, WDM filter, coupler, and circulator.

Aspect 14: The method of any of aspects 11 through 13, wherein the first monitoring device monitors a first combination of the first mirror drift in the first MEMS array and the second mirror drift in the second MEMS array; and wherein the second monitoring device simultaneously monitors a second combination of the second mirror drift in the second MEMS array and the first mirror drift in the first MEMS array.

Aspect 15: The method of aspect 14, wherein the first monitoring device has a higher monitoring sensitivity for mirror drift of the first MEMS array; wherein the second monitoring device has a higher monitoring sensitivity for mirror drift of the second MEMS array; and wherein a relative position drift between the first MEMS array and the second MEMS array is monitored.

Aspect 16: The method of any of aspects 11 through 15, wherein the first light source comprises one of: LED, VCSEL, FP, and DFB.

Aspect 17: The method of any of aspects 11 through 16, wherein the lens structure comprises an achromatic field lens that focuses an incoming signal beam into a center of the second MEMS array.

Aspect 18: The method of any of aspects 11 through 17, wherein the first monitoring device comprises an image relay lens structure, a camera lens, and a sensor array.

Aspect 19: The method of aspect 18, wherein the first monitoring device further comprises a micro lens array configured between the camera lens and the sensor array.

Aspect 20: The method of any of aspects 11 through 19, further comprising: generating, via a second light source, the second reference light beam; receiving, via a second filter positioned between an output collimator array and a second lens structure, the second reference light beam from a second optical device that reflects light and transmits light; and passing, via the second filter, the second reference light beam through the second MEMS array and the first MEMS array.

Aspect 21: A monitoring system for an optical circuit switch device, the monitoring system comprising: a first collimator array with two or more input ports that receive test light beams from at least one test light source that generates the test light beams; a first MEMS array and a second MEMS array which receives the test light beams from the two or more input ports and directs the received test light beams to a second collimator array; the second collimator array that includes two or more output ports that receive the test light beams from the first MEMS array and the second MEMS array; and at least one test light detecting device connected to the two or more output ports that receive the test light beams, wherein the at least one test light detecting device monitors the optical circuit switch device.

Aspect 22: The monitoring system of aspect 21, wherein the at least one test light source comprises a collimated light source.

Aspect 23: The monitoring system of any of aspects 21 through 22, wherein the at least one test light detecting device measures insertion loss and its changes for each of the test light beams.

Aspect 24: The monitoring system of aspect 23, wherein the first MEMS array comprises a first matrix of mirrors and the second MEMS array comprises a second matrix of mirrors; and wherein the first matrix and the second matrix are returned to an optimized position for further testing when the measured insertion loss change is greater than a predetermined threshold.

Aspect 25: The monitoring system of any of aspects 21 through 24, further comprising: a first reference light source that generates a first reference light beam; a first optical device that transmits light and reflects light; a first filter positioned between the first collimator array and a lens structure; the first filter receives the first reference light beam from the first optical device and passes the first reference light beam through the first MEMS array and the second MEMS array; a first monitoring device that receives the first reference light beam that monitors at least a first mirror drift in the first MEMS array; and a second monitoring device that simultaneously receives a second reference light beam that monitors at least a second mirror drift in the second MEMS array.

Aspect 26: The monitoring system of aspect 25, wherein the first reference light beam and second light beam are generated after the at least one test light detecting device determines that a measured insertion loss change for each of the test light beams is greater than a predetermined threshold.

Aspect 27: The monitoring system of any of aspects 21 through 26, wherein the two or more input ports comprise sixteen input ports that are divided into two groups; and wherein the two or more output ports comprise sixteen output ports that correspond to each of the sixteen input ports.

Aspect 28: The monitoring system of any of aspects 21 through 27, wherein the at least one test light source comprises one of: LED, VCSEL, FP, and DFB.

Aspect 29: The monitoring system of aspect 28, wherein the at least one test light source has a same wavelength as signals used by the optical circuit switch device.

Aspect 30: The monitoring system of any of aspects 21 through 29, wherein the at least one test light source comprises two light sources that are combined by a coupler and distributed to the input light ports.

Aspect 31: A method for monitoring an optical circuit switch device, the method comprising: generating, from at least one test light source, test light beams; receiving by a first collimator array with two or more input ports, the test light beams; passing, through the two or more input ports the test light beams through a first MEMS array and a second MEMS array; receiving, by two or more output ports of a second collimator array, the test light beams; receiving by at least one test light detecting device the test light beams; and measuring using the test light beams an insertion loss and its change of the optical circuit switch device.

Aspect 32: The method of aspect 31, wherein the at least one test light source comprises a collimated reference light source.

Aspect 33: The method of any of aspects 31 through 32, wherein the first MEMS array comprises a first matrix of mirrors and the second MEMS array comprises a second matrix of mirrors; and the first matrix and the second matrix are returned to an optimized position for further testing, when the measured insertion loss change is greater than a predetermined threshold.

Aspect 34: The method of any of aspects 31 through 33, further comprising: generating, via a first reference light source, a first reference light beam when the measured insertion loss change is greater than a predetermined threshold; receiving, via a first filter positioned between the first collimator array and a lens structure, the first reference light beam from a first optical device that transmits light and reflects light; passing, via the first filter, the first reference light beam through the first MEMS array and the second MEMS array; receiving, via a first monitoring device, the first reference light beam that monitors at least a first mirror drift in the first MEMS array; and simultaneously receiving, via a second monitoring device, a second reference light beam that monitors at least a second mirror drift in the second MEMS array.

Aspect 35: The method of aspect 34, further comprising: generating, via a second light source, the second reference light beam; receiving, via a second filter positioned between the second collimator array and a second lens structure, the second reference light beam from a second optical device that reflects light and transmits light; and passing, via the second filter, the second reference light beam through the second MEMS array and the first MEMS array.

Aspect 36: The method of any of aspects 34 through 35, wherein the first monitoring device has a higher monitoring sensitivity for mirror drift of the first MEMS array; wherein the second monitoring device has a higher monitoring sensitivity for mirror drift of the second MEMS array; and wherein a relative position drift between the first MEMS array and the second MEMS array is monitored.

Aspect 37: The method of any of aspects 31 through 36, wherein the at least one test light source comprises one of: LED, VCSEL, FP, and DFB.

Aspect 38: The method of aspect 37, wherein the at least one test light source has a same wavelength as signals used by the optical circuit switch device.

Aspect 39: The method of any of aspects 31 through 38, wherein the monitoring is performed periodically while operating the optical circuit switch device.

Aspect 40: The method of aspect 39, wherein when the insertion loss change is greater than a predetermined threshold, the optical circuit switch is placed in a calibration mode.

Each collimator may be made individually. For example, the back focal length (BFL) for each collimator may be adjusted to optimize a Gaussian waist position/Rayleigh length/pointing direction, where collimator spherical surface ROC (radius of curvature) tolerance may be compensated without compromising performance.

It will be appreciated by those persons skilled in the art that the various embodiments described herein are capable of broad utility and application. Accordingly, while the various embodiments are described herein in detail in relation to the exemplary embodiments, it is to be understood that this disclosure is illustrative and exemplary of the various embodiments and is made to provide an enabling disclosure. Accordingly, the disclosure is not intended to be construed to limit the embodiments or otherwise to exclude any other such embodiments, adaptations, variations, modifications, and equivalent arrangements.

The foregoing descriptions provide examples of different configurations and features of one or more embodiments. While certain nomenclature and types of applications/hardware are described, other names and application/hardware usage is possible, and the nomenclature is provided by way of non-limiting examples only. Further, while particular embodiments are described, it should be appreciated that the features and functions of each embodiment may be combined in any way that is within the capability of one skilled in the art. The figures provide additional exemplary details regarding the various embodiments.

The processes and logic flows described in this document can be performed by one or more programmable processors executing one or more computer programs to perform functions by operating on input data and generating output. The processes and logic flows can also be performed by an apparatus that can be implemented as a special purpose logic circuitry, e.g., an FPGA (field programmable gate array) or an ASIC (application-specific integrated circuit).

Computer-readable media suitable for storing computer program instructions and data can include all forms of non-volatile memory, media, and memory devices, including by way of example semiconductor memory devices, e.g., EPROM, EEPROM, and flash memory devices; magnetic disks, e.g., internal hard disks or removable disks; magneto-optical disks; and CD ROM and DVD-ROM disks. The processor and the memory can be supplemented by or incorporated into special-purpose logic circuitry.

It will be appreciated that variations and modifications may be affected by a person skilled in the art without departing from the scope of the various embodiments. Furthermore, one skilled in the art will recognize that such processes and systems do not need to be restricted to the specific embodiments described herein. Other embodiments, combinations of the present embodiments, and uses and advantages of the will be apparent to those skilled in the art from consideration of the specification and practice of the embodiments disclosed herein. The specification and examples should be considered exemplary.

What is claimed is:

1. A monitoring system for an optical circuit switch device, the monitoring system comprising:
a first light source that generates a first reference light beam;
a first optical device that transmits light and reflects light;
a first filter positioned between an input collimator array and a lens structure; the first filter receives the first reference light beam from the first optical device and passes the first reference light beam through a first micro-electro-mechanical (MEMS) array and a second MEMS array;
a first monitoring device that receives the first reference light beam that monitors at least a first mirror drift in the first MEMS array; and
a second monitoring device that simultaneously receives a second reference light beam that monitors at least a second mirror drift in the second MEMS array.

2. The monitoring system of claim 1,
wherein the first monitoring device monitors a first combination of the first mirror drift in the first MEMS array and the second mirror drift in the second MEMS array; and
wherein the second monitoring device simultaneously monitors a second combination of the second mirror drift in the second MEMS array and the first mirror drift in the first MEMS array.

3. The monitoring system of claim 2,
wherein the first monitoring device has a higher monitoring sensitivity for mirror drift of the first MEMS array;
wherein the second monitoring device has a higher monitoring sensitivity for mirror drift of the second MEMS array; and
wherein a relative position drift between the first MEMS array and the second MEMS array is monitored.

4. The monitoring system of claim 1, wherein the lens structure comprises an achromatic field lens that focuses an incoming signal beam into a center of the second MEMS array.

5. The monitoring system of claim 1, further comprising:
a second light source that generates the second reference light beam;
a second optical device that reflects light and transmits light; and
a second filter positioned between an output collimator array and a second lens structure; the second filter receives the second reference light beam from the second optical device and passes the second reference light beam through the second MEMS array and the first MEMS array.

6. A method for monitoring an optical circuit switch device, the method comprising:
generating, via a first light source, a first reference light beam;
receiving, via a first filter positioned between an input collimator array and a lens structure, the first reference light beam from a first optical device that transmits light and reflects light;
passing, via the first filter, the first reference light beam through a first micro-electro-mechanical (MEMS) array and a second MEMS array;
receiving, via a first monitoring device, the first reference light beam that monitors at least a first mirror drift in the first MEMS array; and
simultaneously receiving, via a second monitoring device, a second reference light beam that monitors at least a second mirror drift in the second MEMS array.

7. The method of claim 6,
wherein the first monitoring device monitors a first combination of the first mirror drift in the first MEMS array and the second mirror drift in the second MEMS array; and
wherein the second monitoring device simultaneously monitors a second combination of the second mirror drift in the second MEMS array and the first mirror drift in the first MEMS array.

8. The method of claim 7,
wherein the first monitoring device has a higher monitoring sensitivity for mirror drift of the first MEMS array;
wherein the second monitoring device has a higher monitoring sensitivity for mirror drift of the second MEMS array; and
wherein a relative position drift between the first MEMS array and the second MEMS array is monitored.

9. The method of claim 6, wherein the lens structure comprises an achromatic field lens that focuses an incoming signal beam into a center of the second MEMS array.

10. The method of claim 6, further comprising:
generating, via a second light source, the second reference light beam;
receiving, via a second filter positioned between an output collimator array and a second lens structure, the second reference light beam from a second optical device that reflects light and transmits light; and
passing, via the second filter, the second reference light beam through the second MEMS array and the first MEMS array.

11. A monitoring system for an optical circuit switch device, the monitoring system comprising:
a first collimator array with two or more input ports that receive test light beams from at least one test light source that generates the test light beams;
a first micro-electro-mechanical (MEMS) array and a second MEMS array which receives the test light beams from the two or more input ports and directs the received test light beams to a second collimator array;
the second collimator array that includes two or more output ports that receive the test light beams from the first MEMS array and the second MEMS array; and
at least one test light detecting device connected to the two or more output ports that receive the test light beams, wherein the at least one test light detecting device monitors the optical circuit switch device.

12. The monitoring system of claim 11, wherein the at least one test light detecting device measures insertion loss and its changes for each of the test light beams.

13. The monitoring system of claim 12,
wherein the first MEMS array comprises a first matrix of mirrors and the second MEMS array comprises a second matrix of mirrors; and
wherein the first matrix and the second matrix are returned to an optimized position for further testing, when the measured insertion loss change is greater than a predetermined threshold.

14. The monitoring system of claim 11, further comprising:
a first reference light source that generates a first reference light beam;
a first optical device that transmits light and reflects light;
a first filter positioned between the first collimator array and a lens structure; the first filter receives the first reference light beam from the first optical device and passes the first reference light beam through the first MEMS array and the second MEMS array;
a first monitoring device that receives the first reference light beam that monitors at least a first mirror drift in the first MEMS array; and
a second monitoring device that simultaneously receives a second reference light beam that monitors at least a second mirror drift in the second MEMS array.

15. The monitoring system of claim 14, wherein the first reference light beam and second light beam are generated after the at least one test light detecting device determines that a measured insertion loss change for each of the test light beams is greater than a predetermined threshold.

16. A method for monitoring an optical circuit switch device, the method comprising:
generating, from at least one test light source, test light beams;
receiving by a first collimator array with two or more input ports, the test light beams;
passing, through the two or more input ports the test light beams through a first micro-electro-mechanical (MEMS) array and a second MEMS array;
receiving, by two or more output ports of a second collimator array, the test light beams;
receiving by at least one test light detecting device the test light beams; and
measuring using the test light beams an insertion loss and its change of the optical circuit switch device.

17. The method of claim 16, further comprising:
generating, via a first reference light source, a first reference light beam when the measured insertion loss change is greater than a predetermined threshold;
receiving, via a first filter positioned between the first collimator array and a lens structure, the first reference light beam from a first optical device that transmits light and reflects light;
passing, via the first filter, the first reference light beam through the first MEMS array and the second MEMS array;
receiving, via a first monitoring device, the first reference light beam that monitors at least a first mirror drift in the first MEMS array; and
simultaneously receiving, via a second monitoring device, a second reference light beam that monitors at least a second mirror drift in the second MEMS array.

18. The method of claim 17, further comprising:
generating, via a second light source, the second reference light beam;
receiving, via a second filter positioned between the second collimator array and a second lens structure, the second reference light beam from a second optical device that reflects light and transmits light; and
passing, via the second filter, the second reference light beam through the second MEMS array and the first MEMS array.

19. The method of claim 17,
wherein the first monitoring device has a higher monitoring sensitivity for mirror drift of the first MEMS array;
wherein the second monitoring device has a higher monitoring sensitivity for mirror drift of the second MEMS array; and
wherein a relative position drift between the first MEMS array and the second MEMS array is monitored.

20. The method of claim 16, wherein when the insertion loss change is greater than a predetermined threshold, the optical circuit switch is placed in a calibration mode.
